(19) United States
(12) Patent Application Publication
(10) Pub. No.: US 2009/0025379 A1
(43) Pub. Date: Jan. 29, 2009

(54) SYSTEM FOR RECOVERING ENERGY FROM A HYDRAULIC LIFT

(75) Inventor: Stephen Lee White, Kings Mountain, NC (US)

Correspondence Address: DON W. BULSON (PARK);RENNER, OTTO, BOISSELLE & SKLAR, LLP, 1621 EUCLID AVENUE / 19TH FLOOR, CLEVELAND, OH, 44115, US

(73) Assignee: PARKER-HANNIFIN CORPORATION, Cleveland, OH (US)

(21) Appl. No.: 12/169,240

(22) Filed: Jul. 8, 2008

Related U.S. Application Data
(60) Provisional application No. 60/951,566, filed on Jul. 24, 2007.

(51) Int. Cl. F15B 1/02

(52) U.S. Cl. 60/413

(57) ABSTRACT

A hydraulic circuit that is capable of recovering even very small amounts of energy by magnifying the pressure of the return fluid such that an accumulator can be effectively charged to a suitable operating pressure. Pressurized fluid from the accumulator is then used to drive one or more hydraulic actuators.

### RELATED APPLICATIONS

This application hereby incorporates by reference and claims the benefit of U.S. Provisional Application No. 60/951,566 filed Jul. 24, 2007.

### FIELD OF THE INVENTION

The present invention relates generally to hydraulic systems. More particularly, the invention relates to a system for recovering energy from a hydraulic lift.

### BACKGROUND OF THE INVENTION

Work equipment is widely used for performing tasks more efficiently than could otherwise be done by hand, and/or tasks that would be physically impossible to perform by hand. For example, such equipment can include back-hoes, front-end loaders, lifts, cranes etc. Typically, the equipment includes one or more work implements powered by a hydraulic circuit. In the case of front-end loaders, forklifts, cranes, etc., such hydraulic circuits are often used for raising and/or lowering loads.

In a conventional hydraulic power circuit used for raising and/or lowering loads, a hydraulic pump supplies fluid to one or more hydraulic cylinders configured to raise or lower the work implement, such as a bucket of a front-end loader. In general, the bucket is raised or lowered and returns to its initial position with equal, less, or more mass depending on the particular application. As will be appreciated, however, the weight of a raised bucket, even if empty, exerts a force on the hydraulic cylinder.

In the past, when the bucket was returned to its starting position (e.g., lowered), the pressurized fluid in the cylinder was vented to a reservoir. This resulted in lost power as the energy of the vented fluid was typically dissipated via a throttle valve as the fluid was returned to the reservoir.

One solution for recovering this lost energy has been to direct the return fluid from the hydraulic actuator to an accumulator during the lowering of the implement. The pressurized fluid stored in the accumulator is then rerouted back to the hydraulic actuators during a subsequent load raising procedure. While such systems can work satisfactorily under certain operating conditions, in the case of a very light work implement the pressure of the return fluid may be too low to effectively charge the accumulator. Under such conditions, energy recovery can be difficult and, thus, often little or no energy is recovered.

### SUMMARY OF THE INVENTION

The present invention provides a hydraulic circuit that is capable of recovering even very small amounts of energy by magnifying the pressure of the return fluid such that an accumulator can be effectively charged to a suitable operating pressure. Pressurized fluid from the accumulator is then used to drive one or more hydraulic actuators.

Accordingly, a hydraulic system comprises a plurality of hydraulic actuators configured to raise and lower a load together, a source of pressurized fluid connected to the actuators for supplying pressurized fluid to the actuators for raising the load, and an accumulator for storing pressurized fluid. During lowering, return fluid from less than all of the hydraulic actuators is diverted to the accumulator for energy recovery, and return fluid from at least one of the hydraulic actuators is drained to a reservoir separate from the accumulator thereby increasing the pressure of the return fluid that is diverted to the accumulator from the other hydraulic actuators.

The accumulator can supply pressurized fluid to at least one of the hydraulic actuators during the raising of the load when the pressure of the fluid in the accumulator exceeds a prescribed level. The system can further comprise a fluid diverter operable during lowering to divert return fluid from less than all the actuators to the accumulator. A control valve can be provided that is movable between a closed position blocking flow of fluid from the source of pressurized fluid to the actuators and an open position permitting flow of fluid from the source of pressurized fluid to the actuators for raising the load. The accumulator can be connected to the supply of pressurized fluid via a check valve that permits flow of fluid from the accumulator to the supply when the pressure in the accumulator exceeds a prescribed level. At least one of the plurality of hydraulic actuators can be a hydraulic cylinder, and the source of pressurized hydraulic fluid can include a hydraulic pump.

In accordance with another aspect, a work machine comprises a work implement configured to raise and lower a load, a plurality of hydraulic actuators operatively associated with the work implement, a source of pressurized fluid connected to the hydraulic actuators for supplying pressurized fluid to the actuators for raising the load, and an accumulator for storing pressurized fluid. During lowering, return fluid from less than all of the hydraulic actuators is diverted to the accumulator for energy recovery, and return fluid from at least one of the hydraulic actuators is drained to a reservoir separate from the accumulator thereby increasing the pressure of the return fluid that is diverted to the accumulator from the other hydraulic actuators. The accumulator can supply pressurized fluid to at least one of the hydraulic actuators during the raising of the load when the pressure of the fluid in the accumulator exceeds a prescribed level. The system can further comprise a fluid diverter operable during lowering to divert return fluid from less than all the actuators to the accumulator. A control valve can be provided that is movable between a closed position blocking flow of fluid from the source of pressurized fluid to the actuators and an open position permitting flow of fluid from the source of pressurized fluid to the actuators for raising the load. The accumulator can be connected to the supply of pressurized fluid via a check valve that permits flow of fluid from the accumulator to the supply when the pressure in the accumulator exceeds a prescribed level. At least one of the plurality of hydraulic actuators can be a hydraulic cylinder, and the source of pressurized hydraulic fluid can include a hydraulic pump.

Further features of the invention will become apparent from the following detailed description when considered in conjunction with the drawings.

### BRIEF DESCRIPTION OF THE DRAWINGS

FIG. 1 is a schematic illustration of an exemplary work machine in accordance the invention.

FIG. 2 is a schematic illustration of an exemplary hydraulic circuit in accordance with the invention.

FIG. 3 is the hydraulic circuit of FIG. 2 in a raise (or extend) configuration.

FIG. 4 is the hydraulic circuit of FIG. 2 in a lower (or retract) configuration.

### DETAILED DESCRIPTION

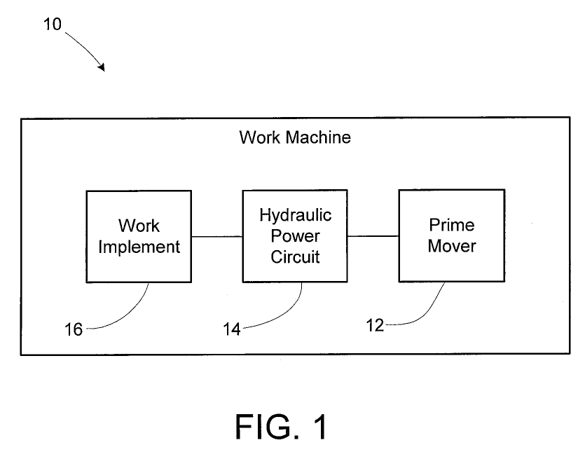

Referring now to the drawings in detail, and initially to FIG. 1, an exemplary work machine 10 is shown. The work machine 10, which can be any of a wide variety of work machines such as a back-hoe, a front-end loader, a crane, a lift, etc., includes a prime mover 12 for supplying power to a hydraulic circuit 14 for powering a work implement 16. The prime mover 12 can be an internal combustion engine or an electric motor, for example. The prime mover may also supply power to other systems of the work machine 10, such as a drive system or auxiliary power systems (not shown). As will be appreciated, the work implement 16 can be any of a wide variety of work implements but will typically be a work implement capable of raising and/or lowering a load such as a bucket, a back-hoe arm, a crane arm, a lift platform, etc.

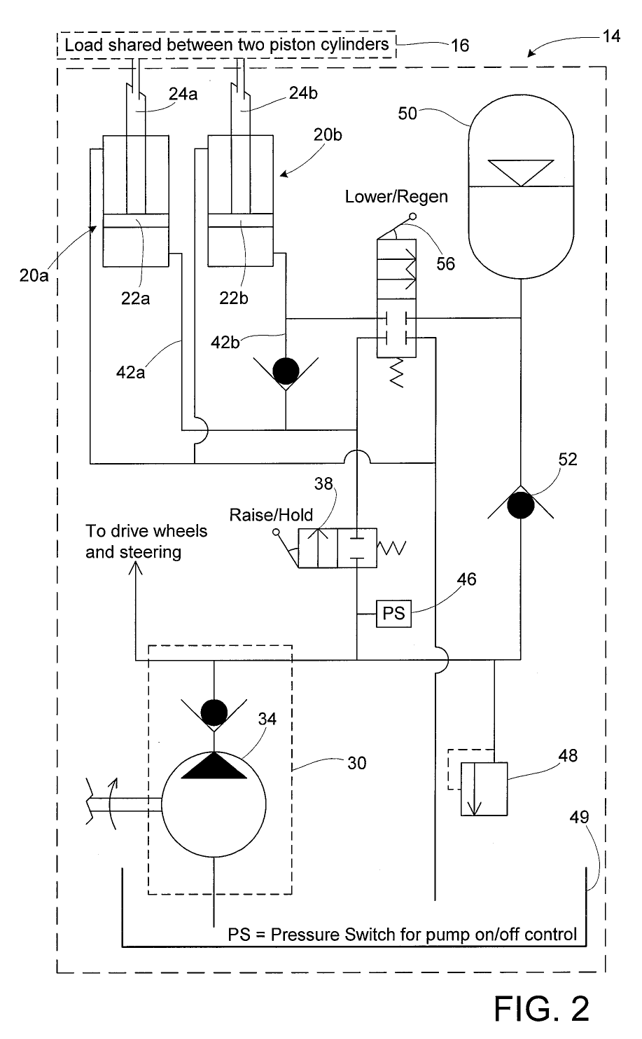

Turning to FIGS. 2-4, and initially to FIG. 2, the details of the exemplary hydraulic circuit 14 are illustrated. The hydraulic circuit 14 includes first and second hydraulic actuators 20a and 20b operatively associated with the work implement 16 for performing work thereon. The hydraulic actuators 20a and 20b are in the form of hydraulic cylinders having pistons 22a and 22b and respective piston rods 24a and 24b coupled to the work implement 16. Each hydraulic actuator 20a and 20b receives pressurized fluid from a source of pressurized fluid 30 for extending the piston rods 24a and 24b to raise the work implement 16.

The pressurized fluid supply 30 includes a pump 34 that is driven by the prime mover 12 (not shown in FIGS. 2-4). The pump 34 is connected to the hydraulic actuators 20a and 20b via a raise/hold valve 38 which controls flow to respective lines 42a and 42b. The raise/hold valve 38 is movable between a closed position blocking flow of fluid from the pump 34 to the hydraulic actuators 20a and 20b, and an open position permitting flow of fluid from the pump 34 to the hydraulic actuators 20a and 20b for raising the load. A pressure switch 46 is provided for cycling the pump 34 on/off to maintain a prescribed pressure for raising operations, while a pressure controlled relief valve 48 relieves fluid to reservoir 49 to prevent pressure from exceeding a prescribed level.

An accumulator 50 is connected to the pressurized fluid supply 30 via a check valve 52 that permits flow of fluid from the accumulator 50 to the pressurized supply 30 when the pressure in the accumulator 50 exceeds a prescribed level, as will be described in greater detail below. The accumulator 50 is also connected via control valve 56 to hydraulic actuator 20b. The control valve 56 is movable from a first position whereat return flow from hydraulic actuator 20b is blocked, to a second position whereat return flow from hydraulic actuator 20b is directed to the accumulator 50 for recovery of energy. Control valve 56 also permits or blocks flow from hydraulic actuator 20a to reservoir 49 during lowering, as will be described below.

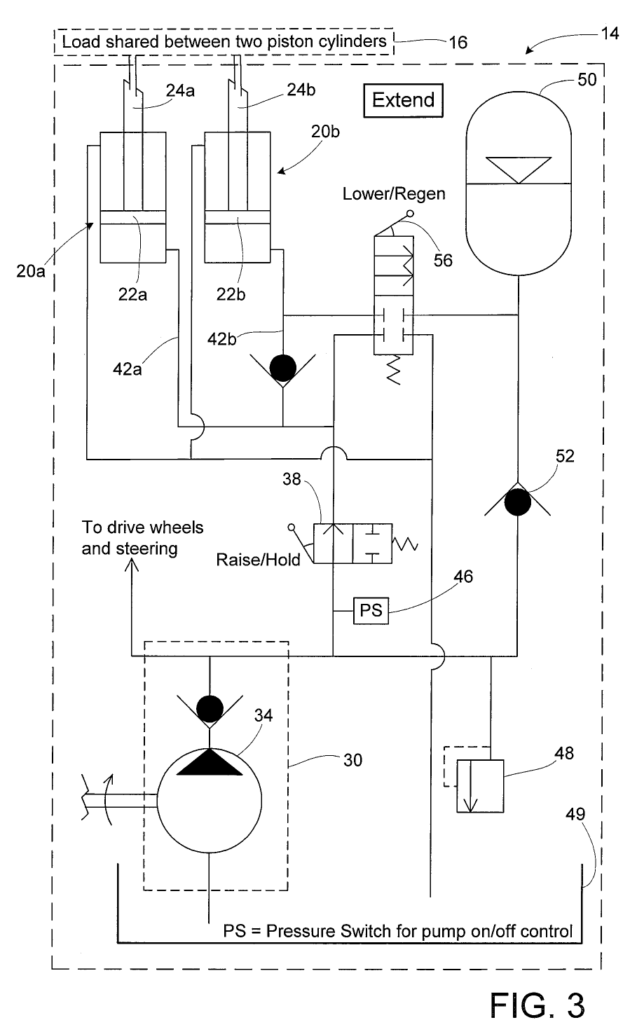

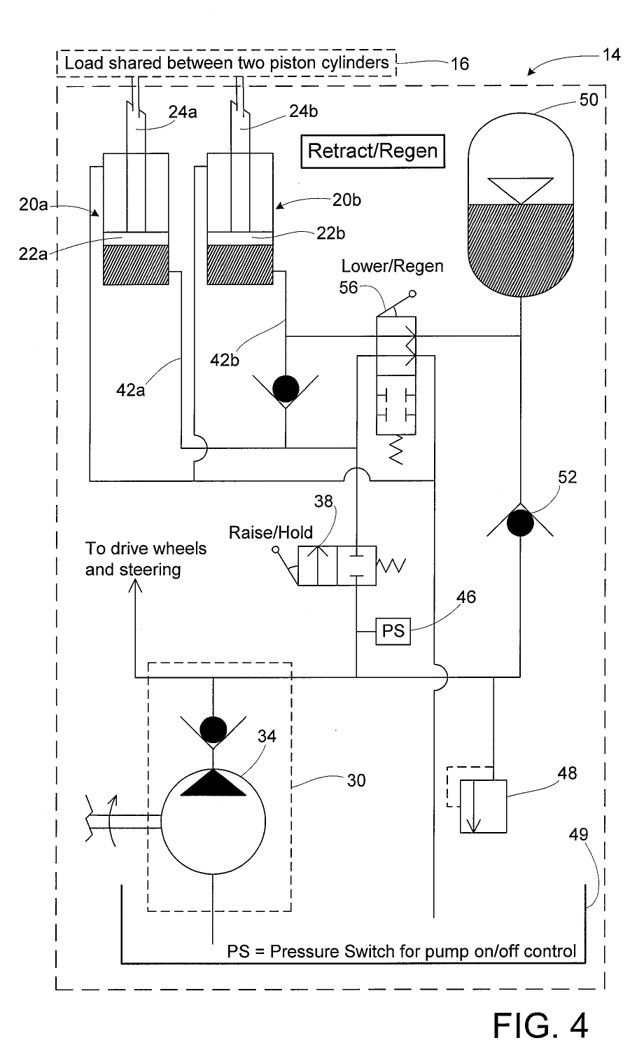

Turning to FIGS. 3 and 4, the operation of the hydraulic circuit 14 will be described in the context of a lift, such as a man-lift. In FIG. 3, the hydraulic circuit is shown in a lifting configuration. When operation of the machine is initiated, the accumulator 50 may typically be nearly empty of hydraulic fluid. Accordingly, the pressure switch 46 will typically be closed (e.g., pump 34 is on) such that all hydraulic fluid needs are supplied by the hydraulic pump 34. As would be typical, when a job first started, the work implement (e.g., lift platform) is in a lowered position and an operator would load thereon the tools and materials the operator needs for the task at hand. The operator might then climb on board and maneuver the machine to the work area.

Once in position, a raise/hold lever associated with raise/hold valve 38 would be moved to open the raise/hold valve 38. The pump 34 then supplies high pressure fluid to the hydraulic actuators 20a and 20b to raise the platform to a desired height. Meanwhile, check valve 52 prevents the accumulator 50 from being charged directly from the pump 34.

When the operator's task is complete, the operator lowers the platform by operating a lower/regen lever associated with to actuate the control valve 56. As described above, the control valve 56 operates to direct return fluid from hydraulic actuator 20b to the accumulator 50. Meanwhile, return fluid from hydraulic actuator 20a is drained to reservoir 49. When hydraulic actuator 20a is drained to the reservoir 49, hydraulic actuator 20b becomes the only support for the platform. Accordingly, the pressure of the fluid within hydraulic actuator 20b is doubled as compared to when both hydraulic cylinders 20a and 20b supported the platform.

As will be appreciated, after a number of cycles the pressure and volume of fluid stored in the accumulator 50 will rise sufficiently to open the pressure switch 46 to turn the pump 34 off. Subsequent requirements for hydraulic fluid will then be met by the stored pressurized fluid in the accumulator 50 until the accumulator discharges enough volume to cause the pressure switch 46 to close. Once the pressure switch 46 closes, the hydraulic pump 34 is once again turned on and will supply any further demand until the accumulator 50 is once again charged.

The invention can be particularly beneficial for use in equipment with electric motors powered by batteries. As will be appreciated, extending battery life is virtually always desirable and the invention may be capable of recovering up to 50% of the energy that would otherwise be lost in a conventional hydraulic circuit that discharges return flow directly to a reservoir.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A hydraulic system comprising:
a plurality of hydraulic actuators configured to raise and lower a load together;
a source of pressurized fluid connected to the actuators for supplying pressurized fluid to the actuators for raising the load; and
an accumulator for storing pressurized fluid;
wherein during lowering, return fluid from less than all of the hydraulic actuators is diverted to the accumulator for energy recovery; and
wherein during lowering, return fluid from at least one of the hydraulic actuators is drained to a reservoir separate from the accumulator thereby increasing the pressure of the return fluid that is diverted to the accumulator from the other hydraulic actuators.

2. A hydraulic system as set forth in claim 1, wherein the accumulator supplies pressurized fluid to at least one of the hydraulic actuators during the raising of the load when the pressure of the fluid in the accumulator exceeds a prescribed level.

3. A hydraulic system as set forth in claim 1, further comprising a fluid diverter operable during lowering to divert return fluid from less than all the actuators to the accumulator.

4. A hydraulic system as set forth in claim 1, further comprising a control valve movable between a closed position blocking flow of fluid from the source of pressurized fluid to the actuators and an open position permitting flow of fluid from the source of pressurized fluid to the actuators for raising the load.

5. A hydraulic system as set forth in claim 1, wherein the accumulator is connected to the supply of pressurized fluid via a check valve that permits flow of fluid from the accumulator to the supply when the pressure in the accumulator exceeds a prescribed level.

6. A hydraulic system as set forth in claim 1, wherein at least one of the plurality of hydraulic actuators is a hydraulic cylinder.

7. A hydraulic system as set forth in claim 1, wherein the source of pressurized hydraulic fluid includes a hydraulic pump.

8. A work machine comprising:
a work implement configured to raise and lower a load;
a plurality of hydraulic actuators operatively associated with the work implement;
a source of pressurized fluid connected to the hydraulic actuators for supplying pressurized fluid to the actuators for raising the load; and
an accumulator for storing pressurized fluid;
wherein during lowering, return fluid from less than all of the hydraulic actuators is diverted to the accumulator for energy recovery; and
wherein during lowering, return fluid from at least one of the hydraulic actuators is drained to a reservoir separate from the accumulator thereby increasing the pressure of the return fluid that is diverted to the accumulator from the other hydraulic actuators.

9. A work machine as set forth in claim 8, wherein the accumulator supplies pressurized fluid to at least one of the hydraulic actuators during the raising of the load when the pressure of the fluid in the accumulator exceeds a prescribed level.

10. A work machine as set forth in claim 8, further comprising a fluid diverter operable during lowering to divert return fluid from less than all the actuators to the accumulator.

11. A work machine as set forth in claim 8, further comprising a control valve movable between a closed position blocking flow of fluid from the source of pressurized fluid to the actuators and an open position permitting flow of fluid from the source of pressurized fluid to the actuators for raising the load.

12. A work machine as set forth in claim 8, wherein the accumulator is connected to the supply of pressurized fluid via a check valve that permits flow of fluid from the accumulator to the supply when the pressure in the accumulator exceeds a prescribed level.

13. A work machine as set forth in claim 8, wherein at least one of the plurality of hydraulic actuators is a hydraulic cylinder.

14. A work machine as set forth in claim 8, wherein the source of pressurized hydraulic fluid includes a hydraulic pump.
